(19) United States
(12) Patent Application Publication
(10) Pub. No.: US 2025/0043062 A1
(43) Pub. Date: Feb. 6, 2025

(54) BLOCKED ISOCYANATES COMPOSITION, USE OF COMPOUNDS AS ISOCYANATES BLOCKING AGENTS

(71) Applicant: MAFLON S.P.A., Milano (MI) (IT)

(72) Inventors: Francesco Maniero, Milano (MI) (IT); Agostino Fenaroli, Milano (MI) (IT); Ivan Viviani, Milano (MI) (IT); Camillo Zarantonello, Milano (MI) (IT)

(21) Appl. No.: 18/713,678

(22) PCT Filed: Feb. 3, 2023
(86) PCT No.: PCT/IB2023/050966

§ 371 Date: May 27, 2024

(30) Foreign Application Priority Data
Feb. 3, 2022 (IT) 102022000001934

(51) Int. Cl. C08G 18/80; C08G 18/08; D06M 13/376; D06M 101/04; D06M 101/34

(52) U.S. Cl. CPC C08G 18/8077; C08G 18/0866; D06M 13/376; D06M 2101/04; D06M 2101/34; D06M 2200/11; D06M 2200/12

(57) ABSTRACT

A composition comprising or, alternatively, consisting of:—isocyanates blocked by means of a blocking agent selected from the group consisting of: (i) optionally 2-pentanone oxime; (ii) 4-methylpentane-2-one oxime; (iii) 5-methyl-3-heptanone oxime; and (iv) a mixture of two or more of (i)-(iii); and—optionally one or more technological additives.

The present invention refers to a composition comprising or, alternatively, consisting of isocyanates blocked by means of a blocking agent selected from the group consisting of (i)-(iv) and, optionally, one or more technological additives.

Furthermore, the present invention refers to a use of (i)-(iv) as an isocyanate blocking agent.

Furthermore, the present invention refers to a use of a composition comprising or, alternatively, consisting of isocyanates blocked by means of a blocking agent; and optionally one or more technological additives; wherein said blocking agent is at least one imidazole compound of general formula (I), in a water repellency and/or oil repellency treatment of a fabric or of a skin.

Furthermore, the present invention refers to a use of an imidazole compound of general formula (I) as a blocked isocyanate blocking agent in a water repellency and/or oil repellency treatment of a fabric or a skin.

Methyl ethyl ketoxime (or 2-butanone oxime, CAS No. 96-29-7; in short, “MEKO”) is a colourless liquid that is the oxime derived from methyl ethyl ketone. MEKO is mainly used as an anti-skinning agent for oil and latex paints and coatings, as it is able to prevent the formation of solid skins above said paints and said coatings. The functioning of MEKO takes place through a bond with drying agents (in particular metal salts) that catalyze the oxidative cross-linking of the oils contained in the paints and in coatings. Once the paint or the coating is applied to a surface, MEKO evaporates, thus allowing the drying process to proceed.

MEKO is also widely used as an isocyanate blocking agent in automobile electrodeposition coating, in painting works, as a curing agent for silicone rubber due to its outstanding water and heat resistance, in fabric treatment in combination with a non-fluorinated resin due to the water repellency properties or in combination with a fluorinated resin due to the water repellency and/or oil repellency properties, and in the printing industry as a fixative.

However, MEKO presents several significant hazards to human health. It has in fact been the subject of the evaluation process (SEv; Substance Evaluation process) whose outcome, reported in the Substance Evaluation Report, led to the drafting of a proposal for harmonized classification (CLH) for the substance.

On the basis of this proposal, ECHA's Risk Assessment Committee (RAC) in September 2018 adopted the opinion to classify MEKO as Carc. 1B, H350: may cause cancer.

The same process has also led to the attribution of the following hazards: Acute Tox. 3, H301: toxic if swallowed; Acute Tox. 4, H312: harmful in contact with skin; Skin Sens. 1, H317-may cause an allergic skin reaction. 1, H318: Causes serious eye damage; Skin Irrit. 2, H315: causes skin irritation; STOT SE 3, H336: may cause drowsiness or dizziness; STOT SE 1, H370 (upper respiratory tract): causes organ damage; and STOT RE 2, H373 (blood system): may cause organ damage in case of prolonged or repeated exposure.

The corresponding inclusion in Annex VI of Regulation (EC) No. 1272/2008 (CLP) entered into force with the 15th ATP in August 2020. As of March 2022, the obligation of classification and labelling as Carc. 1B (H350) for mixtures containing the substance MEKO in concentrations exceeding 0.1% will therefore come into force.

Prior art document JPH05179573A concerns a water repellent and oil repellent agent. Prior art document CN110981750A discloses a method for synthesizing 2-pentanone oxime by means of an ammoxidation reaction.

The Applicant, after a long and intense research and development activity, has identified some oximes that might be used as an alternative to MEKO and that could provide an adequate response to the existing limitations, drawbacks and problems.

In particular, the compounds identified in the present invention have significantly lower toxicity characteristics than MEKO, are normally available on the market in large quantities and at acceptable costs even if-at least currently-they are higher than those of MEKO, are capable of generating blocked isocyanates with neutral (i.e. tending to white or light yellow) colourations, have reaction kinetics comparable to the corresponding products blocked by means of MEKO and show similar and in some cases superior properties compared to those currently used.

Therefore, the object of the present invention is a composition comprising or, alternatively, consisting of isocyanates blocked by means of a blocking agent selected from the group consisting of (i)-(iv) and, optionally, one or more technological additives, having the characteristics as defined in the attached claims.

Further, the object of the present invention is a use of a blocking agent selected from the group consisting of (i)-(iv) as an isocyanate blocking agent, having the characteristics as defined in the attached claims.

Furthermore, the present invention refers to a use of a composition comprising or, alternatively, consisting of isocyanates blocked by means of a blocking agent; and optionally one or more technological additives; wherein said blocking agent is at least one imidazole compound of general formula (I), in a water repellency and/or oil repellency treatment of a fabric or of a skin, having the characteristics as defined in the attached claims.

Furthermore, the present invention refers to a use of an imidazole compound of general formula (I) as blocked isocyanate blocking agent in a water repellency and/or oil repellency treatment of a fabric or skin, having the characteristics as defined in the attached claims.

Preferred embodiments of the present invention will be described hereinafter by way of example, and therefore not by way of limitation with the aid of the tables, in which:

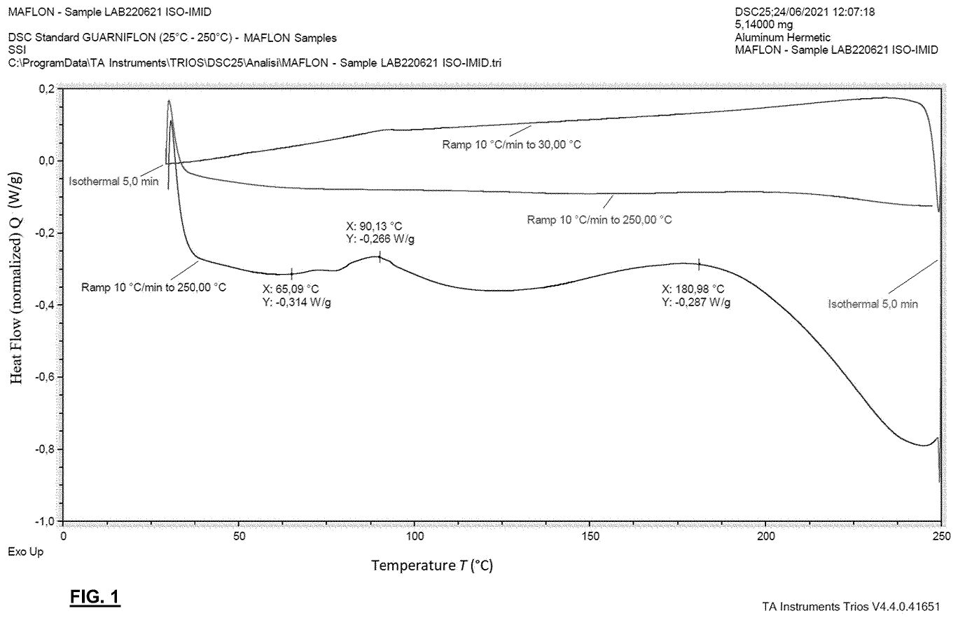

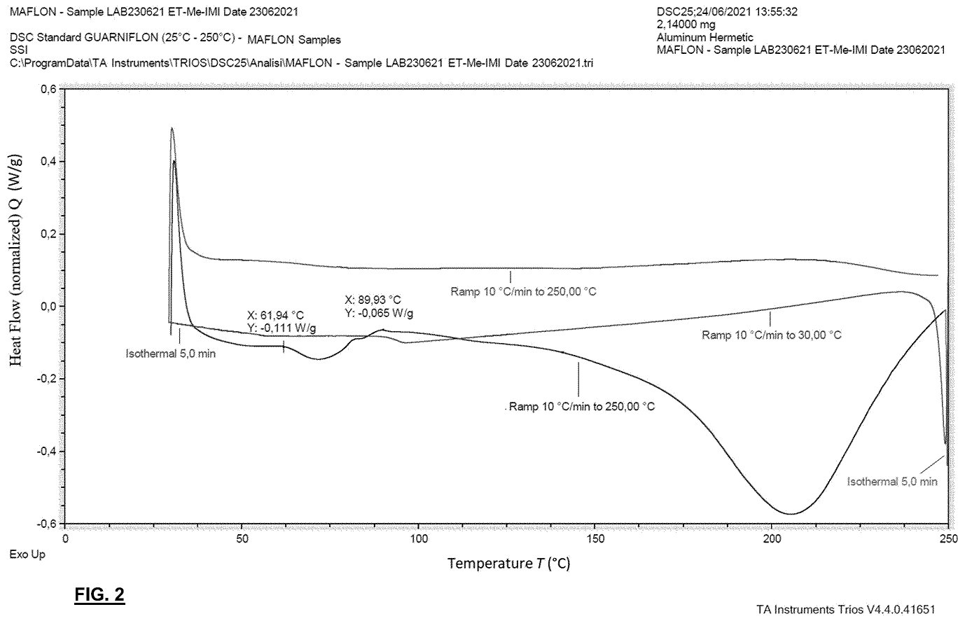

FIG. 1 and FIG. 2: DSC diagrams performed on isocyanates blocked with imidazole compounds according to the examples;

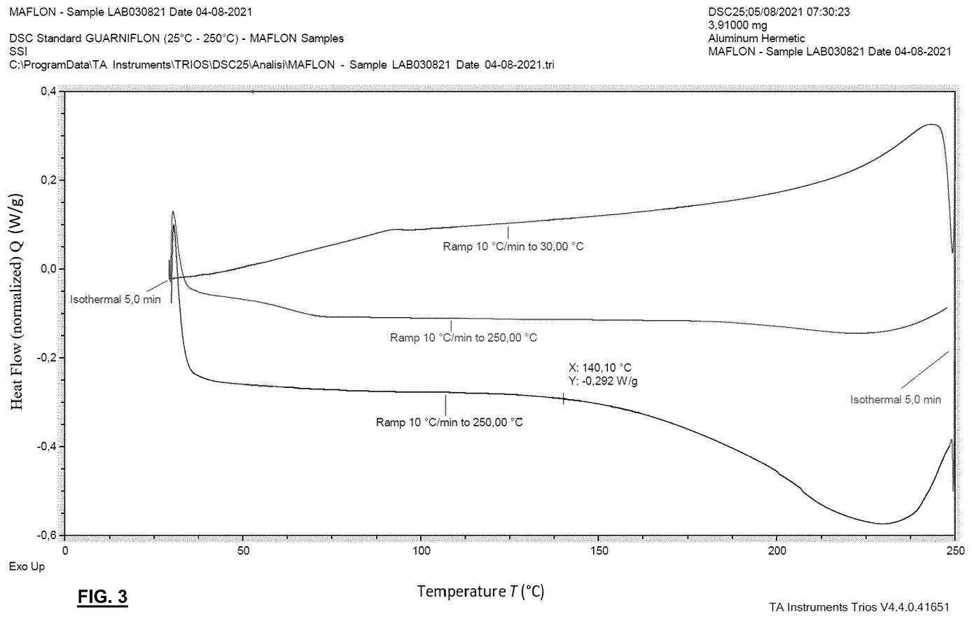

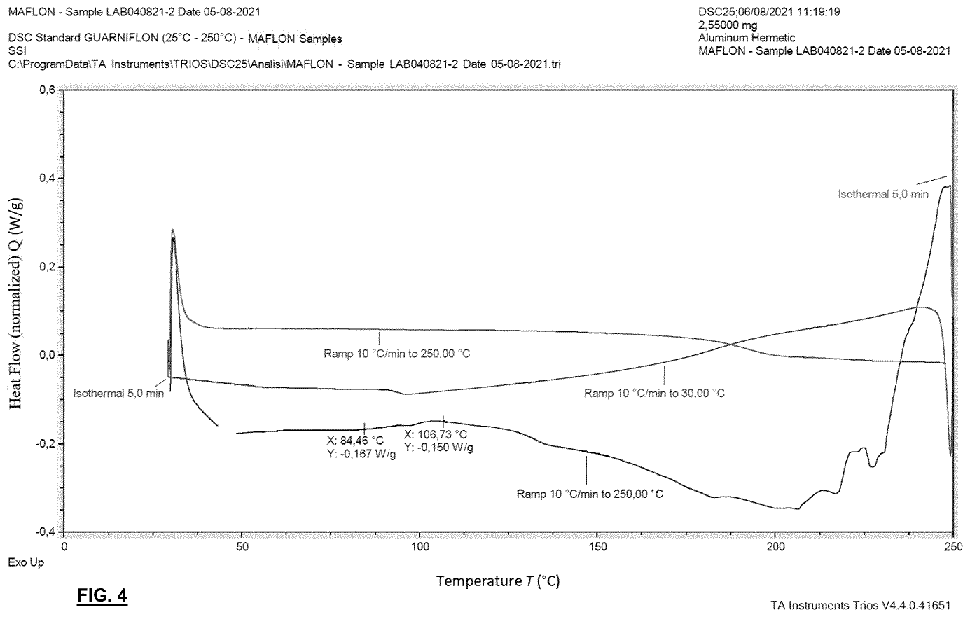

FIG. 3 and FIG. 4: DSC diagrams performed on isocyanates blocked with oximes according to the examples;

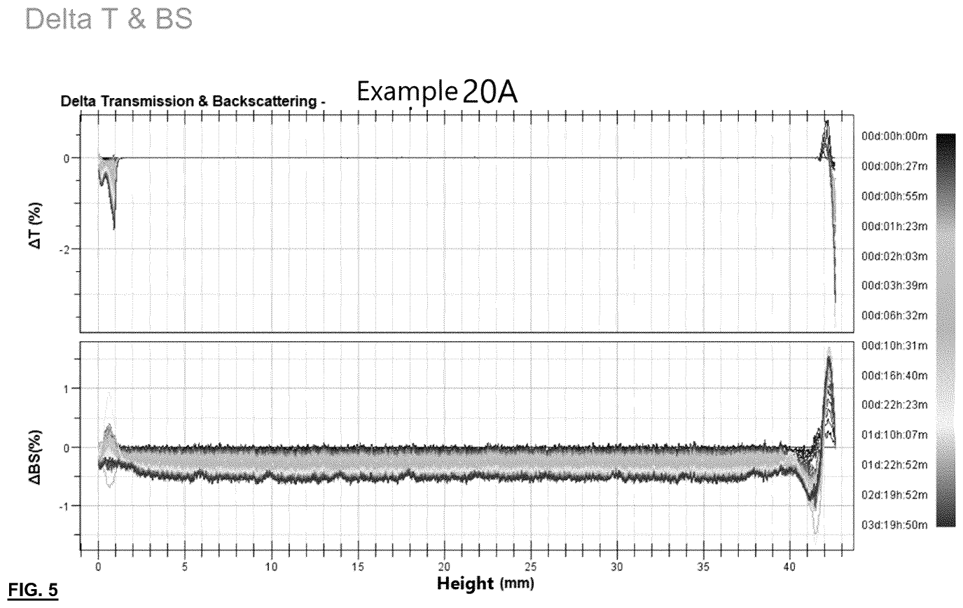

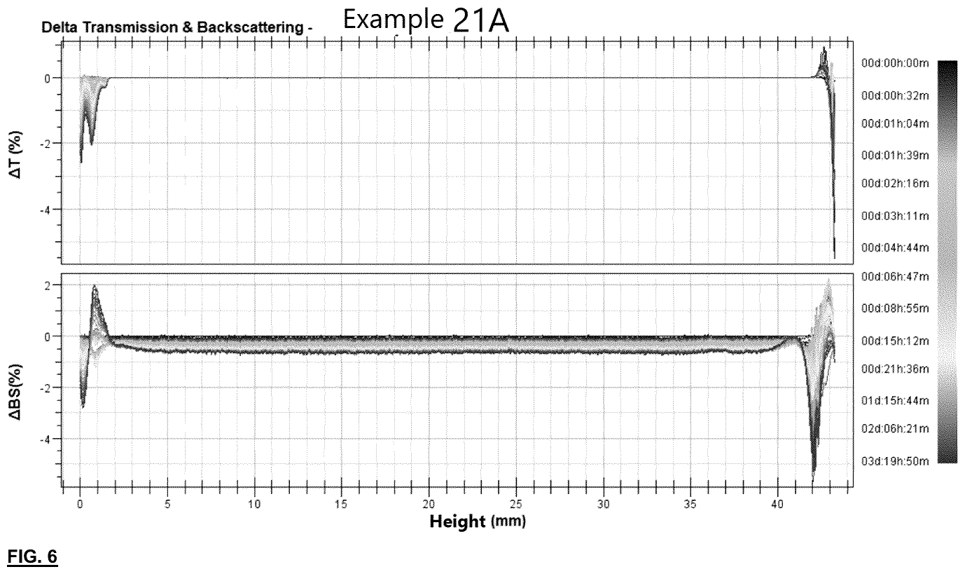

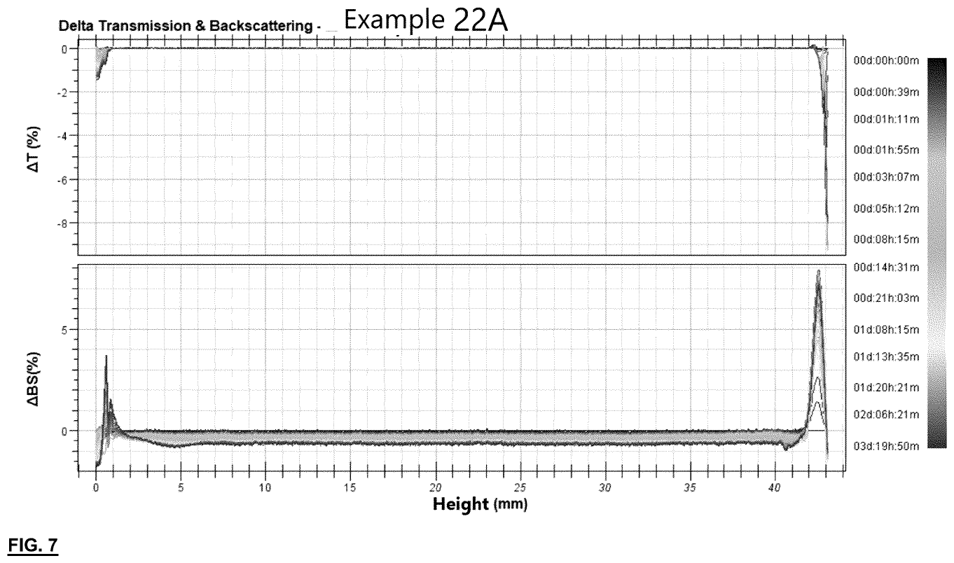

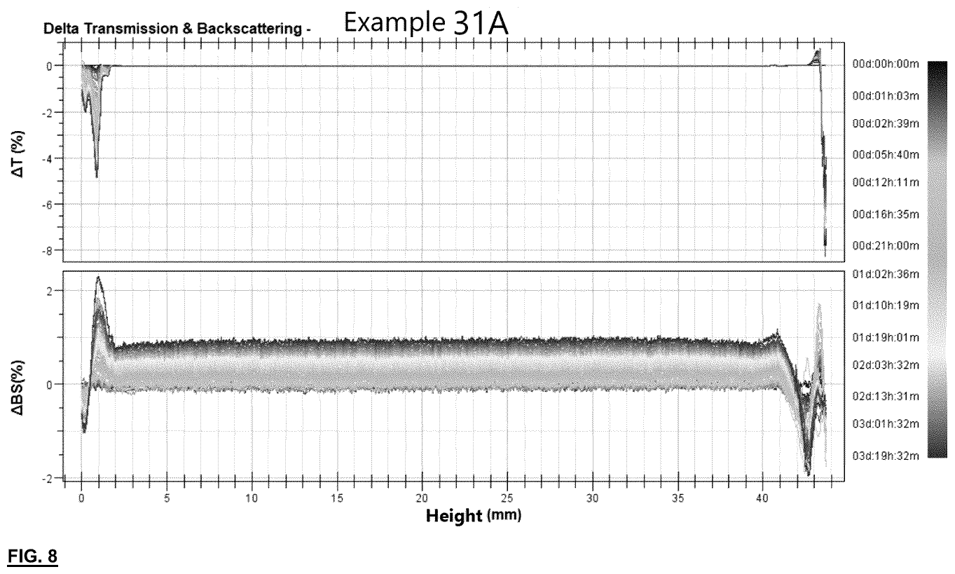

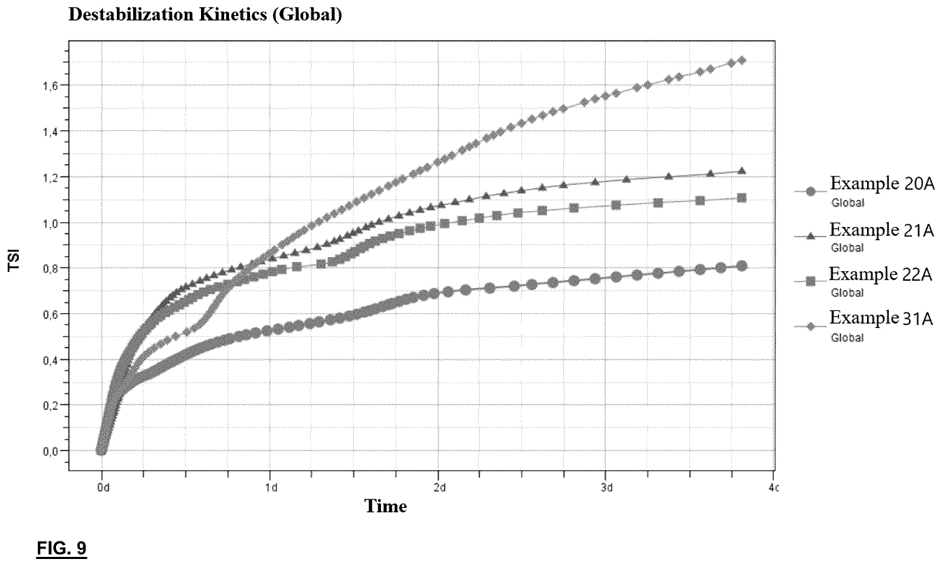

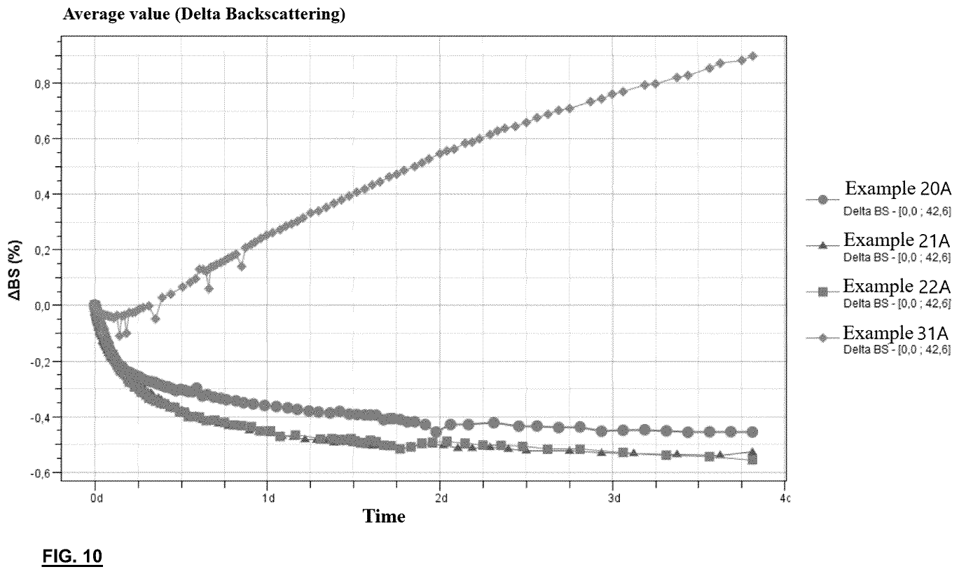

FIG. 5, FIG. 6, FIG. 7, FIG. 8, FIG. 9 and FIG. 10: stability analysis reports by Turbiscan analysis according to the examples;

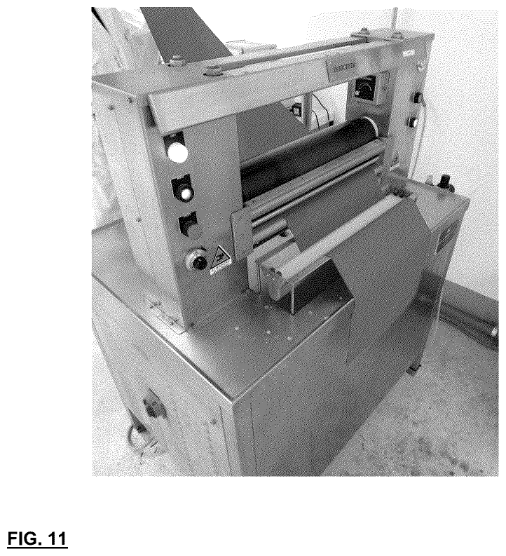

FIG. 11: perspective view of a vertically oriented foulard instrument used in the tests of the examples.

Therefore, an object of the present invention is a composition comprising or, alternatively, consisting of:
isocyanates blocked by means of a blocking agent selected from the group consisting of:
(i) optionally 2-pentanone oxime (CAS No. 623-40-5);
(ii) 4-methylpentane-2-one oxime (CAS No. 105-44-2);
(iii) 5-methyl-3-heptanone oxime (CAS No. 22457-23-4); and
(iv) a mixture of two or more of (i)-(iii);
optionally one or more technological additives.

Within the present description, the term “blocked isocyanates” means the reaction products between an isocyanate and said blocking agent, such that at least one isocyanate function is blocked (non-reactive).

Preferably, said 2-pentanone oxime is not obtained by means of an ammoxidation reaction.

More preferably, said mixture (iv) comprises (iii) 5-methyl-3-heptanone oxime in combination with:
(i) 2-pentanone oxime; and/or
(ii) 4-methylpentane-2-one oxime.

Preferably, in said mixture (iv):
a (iii):(i) or (iii):(ii) by weight ratio is comprised from 20:1 to 1:20, preferably comprised from 10:1 to 1:10, more preferably comprised from 5:1 to 1:5; or
a [(iii)]:[(i)+(ii)] by weight ratio is comprised from 20:1 to 1:20, preferably comprised from 10:1 to 1:10, more preferably comprised from 5:1 to 1:5.

Said isocyanates are preferably selected from the group consisting of:
(a) 1,5-pentamethylene diisocyanate (PDI) and polymers thereof, preferably trimers, optionally biological-based;
(b) toluene diisocyanate (TDI) and adducts thereof, preferably TDI trimers;
(c) polyisocyanates derived from hexamethylenediisocyanate (HDI) obtained by means of trimerization, biuretization and/or allophanatization process(es);
(d) polyisocyanates derived from isophorone diisocyanate (IPDI) obtained by means of trimerization, biuretization and/or allophanatization process(es);
(e) 4,4′-methylene dicyclohexyl diisocyanate (H12MDI);
(f) trimethyl hexamethylene diisocyanate (TMDI);
(g) 1,4-cyclohexyl diisocyanate (CHDI);
(h) tetramethyl xylene diisocyanate (TMXDI); and
(i) any mixture of two or more selected from (a)-(h).

Preferably, said (d) polyisocyanates derived from isophorone diisocyanate (IPDI) obtained by trimerization, biuretization and/or allophanation process(es) comprise or, alternatively, consist of oligomerization products of 3-isocyanatomethyl-3,5,5-trimethylcyclohexyl isocyanate and butane-1-ol and 25 pentane-1-ol and 2-ethylhexane-1-ol, of allophanate type.

More preferably, said (d) comprise the product EC/List no.: 933-047-9, comprising or consisting of the mixture of compounds illustrated in the following general formula (II):

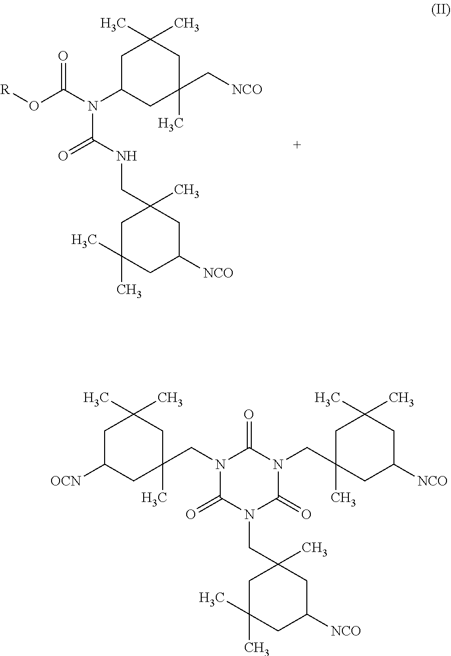

wherein R is an alcoholic residue of butane-1-ol and pentane-1-ol and 2-ethylhexane-1-ol.

Said isocyanates—are more preferably selected from the group consisting of:
(a) 1,5-pentamethylene diisocyanate (PDI) and polymers thereof, preferably trimers, optionally biological-based;
(b) adducts, preferably trimers, of toluene diisocyanate (TDI) obtained from the reaction between trimethylolpropane and toluene diisocyanate, isocyanurate from hexamethylene diisocyanate (HDI) and isocyanurate from isophorone diisocyanate (IPDI), more preferably a reaction product between trimethylolpropane and a mixture of isomers 2,4 toluene diisocyanate and 2,6 toluene diisocyanate, even more preferably said isomers being in a ratio comprised from 90:10 to 70:30, from 85:15 to 75:15 by weight, for example of 80:20 by weight;
(c) hexamethylene 1,6-diisocyanate trimers; and
(i) a mixture of (a)-(c).

Said composition comprising or, alternatively, consisting of blocked isocyanates and optionally one or more technological additives is preferably a non-ionic and/or ionic aqueous suspension or dispersion.

To make said compositions stable in the form of aqueous dispersions of said blocked isocyanates it is possible to insert into the molecule a carboxylated ionic group (for example deriving from dimethylolpropionic acid) or an alkoxylated chain having mono-alcoholic functionality (for example polyethylene glycol mono methyl ether with molecular weight of 350, 500 or 750 amu). More preferably, said suspension or dispersion comprises a mixture of water and co-solvents, preferably in a weight ratio comprised from 2% to 50% and preferably from 5% to 20%.

By way of example only, said co-solvents are selected from the group consisting of propylene glycol dimethyl ether, acetone or other low boiling organic solvent.

Said composition is preferably free of methyl ethyl ketoxime (MEKO).

Furthermore, the object of the present invention is a use of:
(i) optionally 2-pentanone oxime;
(ii) 4-methylpentane-2-one oxime;
(iii) 5-methyl-3-heptanone oxime; or
(iv) a mixture of two or more of (i)-(iii);
as an isocyanate blocking agent.

Preferably, said mixture (iv) comprises (iii) 5-methyl-3-heptanone oxime in combination with:
(i) 2-pentanone oxime; and/or
(ii) 4-methylpentane-2-one oxime.

Preferably, in said mixture (iv):
a (iii):(i) or (iii):(ii) by weight ratio is comprised from 20:1 to 1:20, preferably comprised from 10:1 to 1:10, more preferably comprised from 5:1 to 1:5; or
a [(iii)]:[(i)+(ii)] by weight ratio is comprised from 20:1 to 1:20, preferably comprised from 10:1 to 1:10, more preferably comprised from 5:1 to 1:5.

Furthermore, the subject-matter of the present invention is a use of an imidazole compound of the following general formula (I):

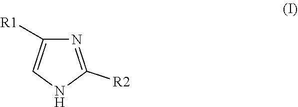

wherein:
R1═H or CH₃;
R2═H, CH₃, CH₂CH₃ or CH(CH₃)₂;
as an isocyanate blocking agent in a water repellency and/or oil repellency treatment of a fabric or skin.

Preferably, said imidazole compound is 2-isopropyl-1H-imidazole (CAS No. 36947-68-9) or 2-ethyl-4-methylimidazole (CAS No. 931-36-2).

More preferably, said imidazole compound is 2-ethyl-4-methylimidazole.

Preferably, said use comprises a deblocking of said isocyanates by said blocking agent in a water repellency and/or oil repellency treatment of a fabric or of a skin.

Furthermore, the object of the present invention is a use of a composition comprising or, alternatively, consisting of:
isocyanates blocked by means of a blocking agent; and
optionally one or more technological additives;
wherein said blocking agent is at least one imidazole compound of the following general formula (I):

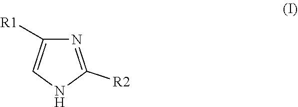

wherein:
R1═H or CH₃;
R2═H, CH₃, CH₂CH₃ or CH(CH₃)₂;
in a water repellency and/or oil repellency treatment of a fabric or skin.

In this description the expression “at least one imidazole compound” means that said composition may comprise a single imidazole compound of general formula (I), or a mixture of two or more imidazole compounds of general formula (I) having R1 and/or R2 different from each other.

Preferably, said imidazole compound or an imidazole compound of said mixture is 2-isopropyl-1H-imidazole (CAS No. 36947-68-9) or 2-ethyl-4-methylimidazole (CAS No. 931-36-2). More preferably, said composition comprises a mixture of 2-isopropyl-1H-imidazole and 2-ethyl-4-methylimidazole.

Even more preferably, said imidazole compound or an imidazole compound of said mixture is 2-ethyl-4-methylimidazole.

Said blocked isocyanates-ionic or non-ionic-are preferably selected from the group consisting of:
(a) 1,5-pentamethylene diisocyanate (PDI) and polymers thereof, preferably trimers, optionally biological-based;
(b) toluene diisocyanate (TDI) and the adducts thereof, preferably trimers of TDI, more preferably a reaction product between trimethylolpropane and a mixture of isomers 2,4 toluene diisocyanate and 2,6 toluene diisocyanate, even more preferably said isomers being in a ratio comprised from 90:10 to 70:30, from 85:15 to 75:25 by weight, for example of 80:20 by weight;
(c) polyisocyanates derived from hexamethylene diisocyanate (HDI) obtained by means of trimerization, biuretization and/or allophanatization process(es), preferably hexamethylene 1,6-diisocyanate trimers;
(d) polyisocyanates derived from isophorone diisocyanate (IPDI) obtained by means of trimerization, biuretization and/or allophanatization process(es);
(e) 4,4′-methylene dicyclohexyl diisocyanate (H12MDI);
(f) trimethyl hexamethylene diisocyanate (TMDI);
(g) 1,4-cyclohexyl diisocyanate (CHDI);
(h) tetramethyl xylene diisocyanate (TMXDI); and
(i) any mixture of two or more selected from (a)-(h).

Said composition is preferably an aqueous suspension or dispersion.

More preferably, said composition is free of methyl ethyl ketoxime (MEKO).

Said composition preferably comprises acrylic acid or methacrylic acid esters (in short: polyacrylates) functionalized with fluorinated chains.

More preferably, said polyacrylates are obtained by means of a copolymerization of the following monomer units (a)-(d):
(a) from 0.1% to 90% by weight of one or more acrylic or methacrylic monomers of general formula

Rf-Rh-OCOC(R₅)═CH₂
wherein:
R₅ is a methyl or hydrogen radical;
Rf is a linear or branched perfluorinated alkyl radical with a number of carbon atoms comprised from 1 to 6, preferably comprised from 4 to 6;
Rh is a group (CH₂)ₙ wherein n is an integer comprised from 1 to 6, preferably comprised from 2 to 4;
(b) from 0.1% to 80% by weight of one or more acrylic or methacrylic monomers of general formula (II):

Rz-OCOC(R₅)═CH₂ (II)
wherein:
Rz is a benzyl radical or an alkyl radical, linear or branched, comprising from 1 to 30 carbon atoms;
R₅ is a methyl or hydrogen radical;
(c) from 1% to 20% by weight of one or more monomers having at least one acrylic or methacrylic functional group and at least one carboxylic function of general formula R²-OCOC(R₅)═CH₂ where R² is (COOH)-(Rh)m— where Rh and R₅ are defined as above and m may assume the value 0 or 1, or itaconic acid;
(d) from 0.1% to 15% by weight of one or more monomers having at least one vinyl function;
(e) from 1% to 20% by weight of one or more acrylic or methacrylic monomers of general formula:

Ry-OCOC(R₅)═CH₂
wherein:
Ry is a radical R—[Si(CH₃)2O]I—Si(CH₃)₂-(Rh)m—, where I is an integer comprised from 2 to 30 and R a linear or branched alkyl group with a number of carbon atoms from 1 to 20, Rh and m defined above;
R₅ is a methyl or hydrogen radical;
(f) 0-15% by weight of one or more acrylic or methacrylic monomers of general formula:

Rz-OCOC(R₅)═CH₂
wherein Rz is a radical —R⁵-(Rh)m—, where R₅ is a hydroxyl or epoxy group and m is defined above.

Said composition further comprises at least one further ingredient selected from paraffin wax and polysiloxane compounds.

Below will be reported some examples, provided by way of non-limiting example, of the present invention.

### EXAMPLES

### Experimental Determination of Deblocking temperature, Reaction Kinetics and Product Colouration

The imidazole compounds 2-isopropyl-1H-imidazole (CAS No. 36947-68-9) and 2-ethyl-4-methylimidazole (CAS No. 931-36-2) were reacted with the following commercially available isocyanates:
Desmodur® Ultra N 3300 (manufactured by Covestro AG): a homopolymer (trimer) of hexamethylene 1,6-diisocyanate (CAS No. 28182-81-2; EC/List No.: 931-274-8);
Polurgreen AD 01: an adduct of toluene diisocyanate (TDI), in particular a reaction product of trimethylolpropane and toluene diisocyanate (mixture of 2,4- and 2,6-isomers in 80:20 by weight ratio);
to give blocked isocyanates.

A DSC (Differential scanning calorimetry) study was performed on the blocked isocyanates to determine the deblocking temperatures thereof. The instrument used is Discovery DSC25AUTO TA INSTRUMENTS (WATERS CORPORATIONS) Serial No. DSC2A-01063.

The proposed DSC method consists of preparing the blocked isocyanates in a nitrogen atmosphere and then performing the following temperature ramps:
a first temperature ramp from 25° C. to 250° C. at 10° C./min, thanks to which a change in slope of the profile can be observed which represents the beginning of the deblocking temperature;
cooling the sample to 25° C.;
a second temperature ramp from 25° C. to 250° C. at 10° C./min, thanks to which a complete deblocking of the isocyanates can be observed.

The results are illustrated in Table 1 below.

TABLE 1

| | | | Deblocking | |
|---|---|---|---|---|
| Test | Isocyanate | Blocking agent | T | |
| LAB | Desmodur ® Ultra N | 2-isopropyl-1H- | 90.1° | C. |
| 220621 | 3300 | imidazole | | |
| LAB | Desmodur ® Ultra N | 2-ethyl-4- | 89.9° | C. |
| 230621 | 3300 | methylimidazole | | |
| LAB | Polurgreen AD 01 | 2-isopropyl-1H- | 93.4° | C. |
| 240621 | | imidazole | | |
| LAB | Polurgreen AD 01 | 2-ethyl-4- | 98° | C. |
| 250621 | | methylimidazole | | |

Exemplary DSC spectra are reported in the following FIG. 1 (relating to test LAB 220621) and FIG. 2 (relating to test LAB 230621).

In general, the reactions between isocyanates and imidazoles result in good reaction kinetics, and the deblocking temperature for both imidazoles tested is comprised in the range from 89.9° C. to 98° C.

As regards the appearance of the blocked isocyanates, the products resulting from the reactions between:
Desmodur® Ultra N 3300 and 2-isopropyl-1H-imidazole; and
Desmodur® Ultra N 3300 and 2-ethyl-4-methylimidazole;
are slightly yellowish.

The three oximes (i), (ii), (iii) subject-matter of the present invention have been individually reacted with the commercial isocyanates discussed above:
Desmodur® Ultra N 3300;
Polurgreen AD 01;
to give blocked isocyanates.

The aforementioned DSC study (Differential scanning calorimetry) was performed on the blocked isocyanates to determine the deblocking temperatures thereof.

The results are illustrated in Table 2 below.

TABLE 2

| | | | Deblocking | |
|---|---|---|---|---|
| Test | Isocyanate | Blocking agent | T | |
| LAB | Desmodur N | 2-pentanone oxime | 140.1° | C. |
| 030821 | 3300 | | | |
| LAB | Polurgreen AD 01 | 2-pentanone oxime | 106.7° | C. |
| 040821 | | | | |
| LAB | Desmodur N | 4-methylpentane-2-one | 133.8° | C. |
| 090921 | 3300 | oxime | | |
| LAB | Polurgreen AD 01 | 4-methylpentane-2-one | 96.6° | C. |
| 100921 | | oxime | | |
| LAB | Desmodur N | 5-methyl-3-heptanone oxime | 119.9° | C. |
| 121021 | 3300 | | | |
| LAB | Polurgreen AD 01 | 5-methyl-3-heptanone oxime | 76.3° | C. |
| 131021 | | | | |

Exemplary DSC spectra are reported in the following FIG. 3 (relating to the LAB030821 test) and FIG. 4 (relating to the LAB040821 test).

In all the products obtained, the colouration was white. The reactivity of all oximes with both isocyanates tested is high.

From the above data it emerges that the three oximes (i), (ii), (iii) have very promising characteristics to be used as blocking agents in isocyanates due to their classification, reactivity, and due to the colouration of the final products obtained.

The temperature values in Table 2 suggest that the three oximes (i), (ii), (iii) may also be used in combination in a single composition to modulate the deblocking temperatures as a function of contingencies, so as to allow flexibility necessary to optimize the processes of use of such compositions.

Furthermore, as can be noted, the deblocking temperatures are not particularly high. This aspect is particularly important with a view of optimizing energy consumption and improving process productivity.

The tests discussed above were repeated by blocking other isocyanate products with oximes (i), (ii), (iii). The isocyanate products are as follows:
Desmodur® eco N 7300 (manufactured by Covestro AG): a 1,5-pentamethylene diisocyanate (PDI; trimer)
Bayhydur® eco 701-90 (manufactured by Covestro AG): a biobased 1,5-pentamethylene diisocyanate (PDI).

Said DSC study was performed on the obtained blocked isocyanates to determine the deblocking temperatures thereof.

The results were included in Table 3 below.

TABLE 3

| | | | Deblocking |
|---|---|---|---|
| Test | Isocyanate | Blocking agent | T |
| LAB 061221 | Desmodur ® eco N | 2-pentanone oxime | 135.9° C. |
| | 7300 | | |
| LAB | Bayhydur ® eco 701- | 2-pentanone oxime | 125.4° C. |
| 061221_A | 90 | | |
| LAB 071221 | Desmodur ® eco N | 4-methyl-2-pentanone | 120.9° C. |
| | 7300 | oxime | |
| LAB | Bayhydur ® eco 701- | 4-methyl-2-pentanone | 117.6° C. |
| 071221_A | 90 | oxime | |
| LAB 091221 | Desmodur ® eco N | 5-methyl-3-heptanone | 120.5° C. |
| | 7300 | oxime | |
| LAB | Bayhydur ® eco 701- | 5-methyl-3-heptanone | 113.6° C. |
| 091221_A | 90 | oxime | |

In all the products obtained, the colouration was white. The reactivity of all oximes with both isocyanates tested is high.

The results obtained are in line with the first series of tests.

It should be noted that the tests carried out on bio-based PDI reveal relatively low deblocking temperatures, with important consequences with a view to optimizing energy consumption and improving process productivity. With the same isocyanate, lower deblocking temperatures are achieved by increasing the chain length of the oxime blocking agent.

### Obtaining Aqueous Compositions of Blocked Polyisocyanates

The general preparation procedure consists in reacting at about 80° C. under stirring a polyisocyanate with a methoxy polyethylene glycol. The latter additive is fundamental for subsequently dispersing the product in water. The product obtained is partially blocked with a blocking agent under stirring at a temperature of about 70° C. The remaining free NCO groups are reacted at about 70° C. with a bifunctional compound diglycol and/or diamine to increase the molecular weight thereof. The reaction mixture is then cooled to 50° C. and then water is added under stirring up to a concentration of ca. 40%.

Methodologies for making compositions that are aqueous suspensions or dispersions of ionic or non-ionic blocked isocyanates are reported below. The following were used as blocking agents:
(i) 2-pentanone oxime; or
(ii) 4-methylpentane-2-one oxime; or
(iii) 5-methyl-3-heptanone oxime;
(iv) a mixture of (i)-(iii)

### Example 1: Blocking Agent (i) 2-pentanone oxime

A glass flask, equipped with an internal thermometer, stirrer and chiller, in a nitrogen atmosphere and at room temperature, is charged—under stirring—with:
100 g (0.518 eq) of Desmodur® Ultra N 3300, having an NCO content of 23%;
19.43 g (0.026 eq) of methoxy PEG 750 previously melted.

The reaction temperature is brought to 80° C. and maintained for about one hour until the determination of the free NCO groups still present by titration gives a value of 17.4% by weight.

It is then cooled to 70° C. to add dropwise in 20 minutes 31.4 g (0.310 eq) of 2-pentanone oxime keeping the mixture in a temperature range comprised from 70° C. to 75° C. After 15 minutes of reaction, the progress is checked by titration until the determination of the free NCO groups still present gives a value of 5.4%.

It is proceeded with the addition of 17.6 g (0.182 eq) of tetraethylene glycol in 20 minutes. After 1 hour of reaction, the disappearance of the NCO groups is checked by FTIR analysis. It is then cooled to about 50° C., to add 252.6 g of demineralised water under stirring.

A stable milky dispersion is obtained, with a solids content of 38.2% by weight.

### Example 2: Blocking Agent (ii) 4-methylpentane-2-one oxime

A glass flask, equipped with an internal thermometer, stirrer and chiller, in a nitrogen atmosphere and at room temperature, is charged—under stirring—with:
100 g (0.518 eq) of Desmodur® Ultra N 3300, having an NCO content of 23%;
19.43 g (0.026 eq) of methoxy PEG 750 previously melted.

The reaction temperature is brought to 80° C. and maintained for about one hour until the determination of the free NCO groups still present by titration gives a value of 17.4% by weight.

It is then cooled to 70° C. to add dropwise in 20 minutes 35.7 g (0.310 eq) of 4-methylpentane-2-one oxime with a temperature range comprised from 70° C. to 75° C. After 15 minutes of reaction, it is checked by titration that the determination of the free NCO groups still present gives a value of 5.4%.

It is proceeded with the addition of 17.6 g (0.182 eq) of tetraethylene glycol in 20 minutes. After 1 hour of reaction, the disappearance of the NCO groups is checked by FTIR analysis. It is then cooled to about 50° C., to add 259.1 g of demineralised water under stirring.

A stable milky dispersion is obtained, with a solid content of 37.7% by weight.

### Example 3: Blocking Agent (iii) 5-methyl-3-heptanone oxime

A glass flask, equipped with an internal thermometer, stirrer and chiller, in a nitrogen atmosphere and at room temperature, is charged—under stirring—with:
100 g (0.518 eq) of Desmodur® Ultra N 3300, having an NCO content of 23%;
19.43 g (0.026 eq) of previously melted methoxy PEG 750 are added under stirring.

The reaction temperature is brought to 80° C. and maintained for about one hour until the determination of the free NCO groups still present by titration gives a value of 17.4% by weight.

It is then cooled to 70° C. to add dropwise in 20 minutes 44.4 g (0.310 eq) of 5-methyl-3-heptanone oxime with a temperature range comprised from 70° C. to 75° C. After 15 minutes of reaction, it is checked by titration that the determination of the free NCO groups still present gives a value of 5.4%.

It is proceeded with the addition of 17.6 g (0.182 eq) of tetraethylene glycol in 20 minutes. After 1 hour of reaction, the disappearance of the NCO groups is checked by FTIR analysis. It is then cooled to about 50° C., to add 272.1 g of demineralised water under stirring.

A stable milky dispersion is obtained, with a solid content of 37.7% by weight.

### Example 4: Blocking Agents Mixture (iv) of oxime (i)-(iii)

A glass flask, equipped with an internal thermometer, stirrer and chiller, in a nitrogen atmosphere and at room temperature, is charged—under stirring—with:
100 g (0.518 eq) of Desmodur® Ultra N 3300, having an NCO content of 23%;
19.43 g (0.026 eq) of methoxy PEG 750 previously melted.

The reaction temperature is brought to 80° C. and maintained for about one hour until the determination of the free NCO groups still present by titration gives a value of 17.4% by weight.

It is then cooled to 70° C. to add dropwise in 30 minutes with a temperature range comprised from 70° C. to 75° C.:
10.47 g (0.103 eq) of 2-pentanone oxime, and thereafter
11.93 g (0.104 eq) of 4-methylpentane-2-one oxime, and finally
14.84 g (0.104 eq) of 5-methyl-3-heptanone oxime.

It is specified that the addition of the different oximes could also take place in a different order from that indicated.

After 15 minutes of reaction, it is checked by titration that the determination of the free NCO groups still present gives a value of 5.4%.

It is proceeded with the addition of 17.6 g (0.182 eq) of tetraethylene glycol in 20 minutes. After 1 hour of reaction, the disappearance of the NCO groups is checked by FTIR analysis. It is subsequently cooled to about 50° C., to add 261.4 g of demineralised water under stirring.

A stable milky dispersion is obtained, with a solid content of 39.6% by weight.

### Comparative Example 5: MEKO Blocking Agents (With Reference to U.S. Pat. No. 20,061,67204)

A glass flask, equipped with an internal thermometer, stirrer and chiller, in a nitrogen atmosphere and at room temperature, is charged—under stirring—with:

70.0 g (0.22013 eq) of Polurgreen AD 01, having an NCO content of 13.2%, 75% by weight;
12.5 g of ethyl acetate;
29.717 g (0.03962 eq) of polyethylene glycol MW 1500 previously melted.

The reaction temperature is brought to 70° C. and kept in a range comprised from 70° C. to 75° C. for about two hours, until the determination of the free NCO groups still present gives a value of 6.7% by weight.

Subsequently, 15.34 g (0.1761 eq) of MEKO is dripped over a period of about 1 hour taking care that the reaction temperature does not exceed 70° C.

After 1 hour of reaction it is checked by FTIR analysis that the prepolymer has the last traces (0.145%) of NCO groups and, at about 60° C., 0.392 g (0.02 eq) of dimethyl ethanol amine is added.

After 1 hour of reaction, the disappearance of the NCO groups is checked by FTIR analysis and, at about 50° C., a mixture formed by 150.86 g of demineralised water and 0.604 g of 70% methanesulphonic acid is added in water. The organic solvent (ethyl acetate) is distilled off under vacuum.

A stable milky dispersion is obtained, with a solids content of 40.5% by weight.

### Example 6: Blocking Agent (i) 2-pentanone oxime

A glass flask, equipped with an internal thermometer, stirrer and chiller, in a nitrogen atmosphere and at room temperature, is charged—under stirring—with:
70.0 g (0.22013 eq) of Polurgreen AD 01;
12.5 g of ethyl acetate;
29.71 g (0.03962 eq) of polyethylene glycol MW 1500 previously melted.

The reaction temperature is brought to 70° C. and kept in a range comprised from 70° C. to 75° C. for about two hours, until the determination of the free NCO groups still present gives a value of 6.7% by weight.

Subsequently, 17.81 g (0.1761 eq) of 2-pentanone oxime is dripped over a period of about 1 hour, taking care that the reaction temperature does not exceed 70° C.

After 1 hour of reaction it is checked by FTIR analysis that the prepolymer has the last traces (0.142%) of NCO groups and, at about 60° C., 0.392 g (0.02 eq) of dimethyl ethanol amine is added.

After 1 hour of reaction, the disappearance of the NCO groups is checked by FTIR analysis and, at about 50° C., a mixture formed by 163.85 g of demineralised water and 0.604 g of 70% methanesulphonic acid is added in water. The organic solvent (ethyl acetate) is distilled off under vacuum.

A stable milky dispersion is obtained, with a solids content of 40.3% by weight.

### Example 7: Blocking Agent (ii) 4-methylpentane-2-one oxime

A glass flask, equipped with an internal thermometer, stirrer and chiller, in a nitrogen atmosphere and at room temperature, is charged—under stirring—with:
70.0 g (0.22013 eq) of Polurgreen AD 01;
12.5 g of ethyl acetate;
29.71 g (0.03962 eq) of polyethylene glycol MW 1500 previously melted.

The reaction temperature is brought to 70° C. and kept in a range comprised from 70° C. to 75° C. for about two hours, until the determination of the free NCO groups still present gives a value of 6.7% by weight.

Subsequently, 20.28 g (0.1761 eq) of 4-methylpentane-2-one oxime is dripped over a period of about 1 hour, taking care that the reaction temperature does not exceed 70° C.

After 1 hour of reaction it is checked by FTIR analysis that the prepolymer has the last traces (0.139%) of NCO groups and, at about 60° C., 0.392 g (0.02 eq) of dimethyl ethanol amine is added.

After 1 hour of reaction, the disappearance of the NCO groups is checked by FTIR analysis and, at about 50° C., a mixture formed by 167.87 g of demineralised water and 0.604 g of 70% methanesulphonic acid is added in water. The organic solvent (ethyl acetate) is distilled off under vacuum.

A stable milky dispersion is obtained, with a solids content of 40.4% by weight.

### Example 8: Blocking Agent (iii) 5-methyl-3-heptanone oxime

A glass flask, equipped with an internal thermometer, stirrer and chiller, in a nitrogen atmosphere and at room temperature, is charged—under stirring—with:
70.0 g (0.22013 eq) of Polurgreen AD 01;
12.5 g of ethyl acetate;
29.71 g (0.03962 eq) of polyethylene glycol MW 1500 previously melted.

The reaction temperature is brought to 70° C. and kept in a range comprised from 70° C. to 75° C. for about two hours, until the determination of the free NCO groups still present gives a value of 6.7% by weight.

Subsequently, 25.22 g (0.1761 eq) of 5-methyl-3-heptanoneoxime is dripped over a period of about 1 hour, taking care that the reaction temperature does not exceed 70° C.

After 1 hour of reaction it is checked by FTIR analysis that the prepolymer has the last traces (0.139%) of NCO groups and, at about 60° C., 0.392 g (0.02 eq) of dimethyl ethanol amine is added.

After 1 hour of reaction, the disappearance of the NCO groups is checked by FTIR analysis and, at about 50° C., a mixture formed by 175.94 g of demineralised water and 0.604 g of 70% methanesulphonic acid is added in water. The organic solvent (ethyl acetate) is distilled off under vacuum.

A stable milky dispersion is obtained, with a solids content of 40.3% by weight.

### Example 9: Blocking Agent 2-isopropyl-1H-imidazole

A glass flask, equipped with an internal thermometer, stirrer and chiller, in a nitrogen atmosphere and at room temperature, is charged—under stirring—with:
100 g (0.518 eq) of Desmodur® Ultra N 3300, having an NCO content of 23%;
19.42 g (0.026 eq) of methoxy PEG 750 previously melted.

The reaction temperature is brought to 80° C. and maintained for about one hour until the determination of the free NCO groups still present by titration gives a value of 17.4% by weight.

It is then cooled to 70° C. to add in portions in 20 minutes 34.1 g (0.310 eq) of 2-isopropyl-1H-imidazole with a temperature range comprised from 70° C. to 75° C. After 15 minutes of reaction, it is checked by titration that the determination of the free NCO groups still present gives a value of 5.5%.

It is proceeded with the addition of 17.6 g (0.182 eq) of tetraethylene glycol in 20 minutes. After 1 hour of reaction, the disappearance of the NCO groups is checked by FTIR analysis. It is then cooled to about 50° C., to add 256.7 g of demineralised water under stirring.

A stable milky dispersion is obtained, with a solid content of 38.5% by weight.

### Example 10: Blocking Agent 2-ethyl-4-methylimidazole

A glass flask, equipped with an internal thermometer, stirrer and chiller, in a nitrogen atmosphere and at room temperature, is charged—under stirring—with:
100 g (0.518 eq) of Desmodur® Ultra N 3300, having an NCO content of 23%;
19.42 g (0.026 eq) of methoxy PEG 750 previously melted.

The reaction temperature is brought to 80° C. and maintained for about one hour until the determination of the free NCO groups still present by titration gives a value of 17.4% by weight.

It is then cooled to 70° C. to add in portions in 20 minutes 34.1 g (0.310 eq) of 2-ethyl-4-methylimidazole with a temperature range comprised from 70° C. to 75° C. After 15 minutes of reaction, it is checked by titration that the determination of the free NCO groups still present gives a value of 5.5%.

It is proceeded with the addition of 17.6 g (0.182 eq) of tetraethylene glycol in 20 minutes. After 1 hour of reaction, the disappearance of the NCO groups is checked by FTIR analysis. It is then cooled to about 50° C., to add 256.6 g of demineralised water under stirring.

A stable milky dispersion is obtained, with a solid content of 38.4% by weight.

### Stability Test of the Compositions

The three oximes (i), (ii), (iii) subject-matter of the present invention have been employed in a typical composition (referred to in Examples 1, 2, 3) and the respective products in water have been tested to evaluate their performance in comparison with the current marketed products.

Four tests have been carried out so named:
Example 20A: composition with (i) 2-pentanone oxime;
Example 21A: composition with (ii) 4-methylpentane-2-one oxime;
Example 22A: composition with (iii) 5-methyl-3-heptanone oxime;
Example 31A: composition with mixture of oxime (i)-(iii).

To assess water stability, a stability study was carried out using the Turbiscan Tower instrument. Such an instrument is configured to analyse destabilization mechanisms in concentrated dispersed media, and thus to provide accelerated ageing testing on unstressed real products.

The experimental conditions are shown in Table 4 below.

TABLE 4

| | | | | | | | |
|---|---|---|---|---|---|---|---|
| | | | | No | T | Tube | |
| Barcode | Start date | Scan Ref. | Duration | scanning | (° C.) | bottom | Level |

| | | | | | | | |
|---|---|---|---|---|---|---|---|
| [symbol] | ott 20 | 51 mn 56 [symbol] | [symbol] 19 h | 326 | 39.99 | 4.64 | 47.21 |
| Example | 2021, | | 30 mn 3 | | | | |
| 20A | 04:22:38 PM | | | | | | |
| [symbol] | ott 20 | 51 mn 57 [symbol] | [symbol] 19 h | 326 | 39.99 | 4.30 | 47.51 |
| Example | 2021, | | 30 mn 3 | | | | |
| 21A | 04:22:46 PM | | | | | | |
| [symbol] | ott 20 | 51 mn 56 [symbol] | [symbol] 19 h | 326 | 39.99 | 4.56 | 47.62 |
| Example | 2021, | | 30 mn 3 | | | | |
| 22A | 04:22:56 PM | | | | | | |
| [symbol] | dic 15 | 51 mn 56 s | [symbol] d 19 h | 326 | 40.00 | 4.37 | 48.04 |
| Example | 2021, | | 32 mn [symbol] | | | | |
| 31A | 05:32:51 PM | | | | | | |

[symbol]

indicates data missing or illegible when filed

The Turbiscan analysis report is shown in FIG. 5, FIG. 6, FIG. 7, FIG. 8, FIG. 9 and FIG. 10.

All four formulations prepared were stable as they did not show any sedimentations. The graphs reported in FIG. 5, FIG. 6, FIG. 7, FIG. 8 Delta Backscattering ΔBS (%) vs sample height (mmm), show a linear trend close to 0. The TSI (grade of destabilization) vs time at 40° C., FIG. 10, is less than 2 in all 4 tests for the entire duration of the analysis, 4 days.

FIG. 10 shows Delta Backscattering ΔBS (%) vs time at 40° C. In all 4 samples the ΔBS (%) is less than 1% confirming that the 4 products are stable. Visually the sample of Example 31A is more translucent and with finer particles than the other 3 samples. It is likely that the positive trend of Delta Backscattering % is due to better light reflection due to finely dispersed crystals and better homogeneity of the solution.

### Evaluation of Performance on Fabrics

### Application Tests on Fabrics

The base+isocyanate compositions have a good yield, comparable and sometimes superior to the reference composition (Comparative Example 5 isocyanate blocked with MEKO).

The percentages indicated below are percentages by weight of the individual component with respect to the total weight of formula, unless otherwise specified.

### Methodology for the Treatment of Fabrics With Foulard (Padding Method)

The treatment and evaluation of treated fabrics comprise three steps:
1. Preparation of the protective agent solution
2. Treatment of the substrate
3. Performance evaluation by AATCC test
   1. Preparation of the protective agent solution

The wetting solutions used for the Padding method are obtained by diluting the textile protective agent solution combined with the cross-linking agent. The mixture between the two components usually has a proportion comprised from 90:10 to 80:20, respectively of protective agent and crosslinking agent. The dilution is carried out before treatment, with distilled water, to obtain a concentration comprised between 30 g/L and 100 g/L. Depending on the treated fabric or skin and the type of protective agent applied, a more or less diluted solution will be used (for example, higher weights are used on cotton compared to polyester or polyamide; as a further example, a lower weight will be needed for a fluorinated product compared to a non-fluorinated product).

### 2. Treatment of the Substrate

(I) Cut a piece of substrate (skin or fabric, e.g. cotton, polyester, polyamide, . . . ) with approximate dimensions of 60 cm×20 cm;
(II) Weigh the dry substrate on analytical scales;
(III) Turn on the foulard instrument (FIG. 11; Model FL 500, manufacturer Off. Electromechanical Gavazzi), setting a roller pressure at 3 bar and a rotation speed at 0.60 cm/minute;
(IV) Fit a bath for the wetting solution containing the protective agent on the front part of the foulard instrument, inserting the wetting solution (in a volume comprised from half a litre to 1 litre);
(V) Start the rollers of the foulard instrument, inserting the substrate between them after it has been immersed in the bath of the wetting solution;
(VI) Slide the substrate out of the rollers, pick it up and re-introduce it between the two rollers for a second step (avoiding passing the substrate into the bath with the wetting solution);
(VII) Weigh the wet substrate, so as to be able to evaluate the amount of wetting solution remained in the substrate (pick up of the substrate), according to the following formula:

$$Pick up = ( ( final substrate weight - initial substrate weight ) /$$

$$initial substrate weight ) * 100$$

(VIII) Carry out the drying step by inserting the substrate in an oven at 120° C. for 1.5 minutes;
(IX) Carry out a crosslinking step (curing) by inserting the substrate in an oven at 150° C. for 3 minutes;
(X) Take the dry substrate and carry out the evaluation tests.

### 3. Performance Evaluation by AATCC Test

The tests that are usually carried out to evaluate the yield of a treated substrate are the following:

### A. AATCC 22: Spray Test

A treated substrate is placed tilted at 45° below a funnel from which 250 ml of deionized water are poured. The wettability of the treated substrate and the resistance thereof are then evaluated according to the AATCC 22 evaluation. The results of the tests carried out according to AATCC 22-Spray test are illustrated in schematic form in Table 5 below.

TABLE 5

| Dry | Product (%) | |
|---|---|---|
| Product A | 33.38 | Product A --> Non-fluorinated resin |
| Product B | 34.51 | Product B --> Product A (80%) + |
| | | 20% Isocyanate blocked with MEKO |
| FORMULA 20A | 38.16 | Formula 20a --> Product A (80%) + |
| | | Example 20A (20%) |
| FORMULA 21A | 37.73 | Formula 21A --> Product A (80%) + |
| | | Example 21A (20%) |
| FORMULA 22A | 38.27 | Formula 22A --> Product A (80%) + |
| | | Example 22A (20%) |
| FORMULA 31A | 39.55 | Formula 31A --> Product A (80%) + |
| | | Example 31A (20%) |

Materials: Cotton
Polyamide
Process: Application: Padding (P=3 bar)
Drying: 120° C./1.5 min
Cross-linking: 150° C./3 min
Required tests: Spray Test (according to AATCC 22)
Results:

TABLE 5.A

| | | SPRAY TEST - COTTON - AATCC 22 | | | | |
|---|---|---|---|---|---|---|
| | | Washes (40° C. - 30 min)/Ironing | | | | |
| Product | g/L | 0 | 2 | 4 | 6 | 8 |
| Product A | 50 | 90/100 | 90 | 70/80 | 50/70 | 50 |
| Product B | 50 | 90/100 | 90/100 | 90/100 | 90 | 90 |
| Formula 20A | 50 | 90/100 | 90/100 | 90/100 | 90 | 90 |
| Formula 21A | 50 | 90/100 | 90/100 | 90/100 | 90 | 90 |
| Formula 22A | 50 | 90/100 | 90/100 | 90/100 | 90 | 90 |
| Formula 31A | 50 | 90/100 | 90/100 | 90/100 | 90 | 90 |

TABLE 5.B

| | | SPRAY TEST - POLYAMIDE - AATCC 22 | | | | |
|---|---|---|---|---|---|---|
| | | Washes (40° C. - 30 min)/Ironing | | | | |
| Product | g/L | 0 | 2 | 4 | 6 | 8 |
| Product A | 50 | 90/100 | 90 | 90 | 80 | 70 |
| Product B | 50 | 90/100 | 90/100 | 90/100 | 90 | 90 |
| Formula 20A | 50 | 90/100 | 90/100 | 90/100 | 90 | 90 |
| Formula 21A | 50 | 90/100 | 90/100 | 90/100 | 90 | 90 |
| Formula 22A | 50 | 90/100 | 90/100 | 90/100 | 90 | 90 |
| Formula 31A | 50 | 90/100 | 90/100 | 90/100 | 90 | 90 |

From the previous Tables 5.A and 5.B the following conclusions can be drawn:

The non-fluorinated resin product applied without the use of a blocked isocyanate shows both in the cotton and in the polyamide a low resistance to washes. The photographic index already drops after 4 washes to 70/80 for cotton and to 80 after 6 washes in the case of polyamide.

All new products prepared with non-fluorinated base and isocyanates blocked with oxime (i), (ii), (iii) and oxime mixture (iv) show after four washes water repellency properties similar to Product B blocked with MEKO. The water repellency properties are constant with a higher number of washes confirming that the products subject-matter of the present invention are effective crosslinkers. The effectiveness of the products subject-matter of the present invention is also confirmed by the good performance despite containing a lower % NCO compared to standard products blocked with MEKO.

Further tests, carried out at lower temperatures (drying 100° C. and crosslinking 120° C.) using (iii) 5-methyl-3-heptanone oxime as blocking agent, show slightly higher water repellency properties (spray test) compared to formulations containing isocyanates blocked with MEKO. In this regard, see Table 6 below, where Product C is fluorinated resin (see Example 11 in this regard).

TABLE 6

| Dry | Product (%) | |
|---|---|---|
| Product C | 30.05 | |
| Product D | 32.04 | Product D --> Product C (80%) + |
| | | blocked Isocyanate MEKO (20%) |
| Product 22A | 38.27 | Formula 22A --> Product C (80%) + |
| | | Example 22A (20%) |

Materials: Cotton
   Polyamide
   Polyester
Process: Application: Padding (P=3 bar)
   Drying: 100° C./1.5 min
   Cross-linking: 120° C./3 min
Tests: Spray Test (AATCC 22)
Results:

TABLE 6.A

SPRAY TEST - COTTON - AATCC 22
Washes (40° C.-30 min)/Ironing

| Product | g/L | 0 | 5 |
|---|---|---|---|
| Formula 22A | 20 | 90/100 | 80 |
| Formula D | 20 | 90/100 | 70 |

TABLE 6.B

SPRAY TEST - PA - AATCC 22
Washes (40° C.-30 min)/Ironing

| Product | g/L | 0 | 5 |
|---|---|---|---|
| Formula 22A | 20 | 100 | 90/100 |
| Formula D | 20 | 100 | 90 |

TABLE 6.C

SPRAY TEST - PES - AATCC 22
Washes (40° C.-30 min)/Ironing

| Product | g/L | 0 | 5 |
|---|---|---|---|
| Formula 22A | 20 | 100 | 90 |
| Formula D | 20 | 100 | 90 |

Similar results regarding stability and water repellency were obtained by using as blocking agents 2-isopropyl-1H-imidazole Example 9 and 2-ethyl-4-methylimidazole Example 10.

### B. AATCC 118: Oil Repellency

Drops of oils with different surface tensions are applied to a treated substrate. The drops are removed after 30 seconds and the absorption of the drop by the treated surface is evaluated. The oil repellency grade is identified as the highest among the tested grades that is not completely absorbed within 30 seconds. The following Table 7 illustrates the oil grades applied:

TABLE 7

| Test number | | Surface tension |
|---|---|---|
| Alkanes | Oil | mN/m |
| 1 | Refined mineral oil | 31.50 |
| 2 | Mineral Oil/n Hexadecane (65/35) | 29.20 |
| 3 | n-Hexadecane | 27.30 |
| 4 | n-Tetradecane | 26.20 |
| 5 | n-Dodecane | 24.60 |
| 6 | n-Decane | 23.60 |
| 7 | n-Octane | 21.80 |
| 8 | n-Heptane | 19.70 |

The tests performed have been reported in Table 8.

TABLE 8

| Dry | Product (%) | |
|---|---|---|
| Product C | 30.05 | Product C --> Fluorinated Resin |
| FORMULA 20A | 38.16 | Formula 20a --> Product C (80%) + |
| | | Example 20a (20%) |
| FORMULA 21A | 37.73 | Formula 21A --> Product C (80%) + |
| | | Example 21A (20%) |
| FORMULA 22A | 38.27 | Formula 22A --> Product C (80%) + |
| | | Example 22A (20%) |
| FORMULA 31A | 39.55 | Formula 31A --> Product C (80%) + |
| | | Example 31A (20%) |
| Product D | 32.04 | Product D --> Product C (80%) + |
| | | Isocyanate blocked with MEKO (20%) |

Materials: Cotton
   Polyamide
   Polyester
Process: Application: Padding (P=3 bar)
   Drying: 120° C./1.5 min
   Cross-linking: 150° C./3 min
Required Tests: AATCC 118 (oil repellency)
Results:

TABLE 8.A

| | | AATCC 118 - COTTON | | |
|---|---|---|---|---|
| | | Washes (40° C.-30 min)/Ironing | | |
| Product | g/L | 0 | 5 | 10 |
| Formula 20A | 25 | 4 | 4 | 3/4 |
| Formula 21A | 25 | 4/5 | 4 | 3/4 |
| Formula 22A | 25 | 4/5 | 4/5 | 4 |
| Formula 31A | 25 | 4 | 4 | 3/4 |
| Product D | 25 | 4 | 4 | 3/4 |

TABLE 8.B

| | | AATCC 118 - POLYESTER | | |
|---|---|---|---|---|
| | | Washes (40° C.-30 min)/Ironing | | |
| Product | g/L | 0 | 5 | 10 |
| Formula 20A | 25 | 5 | 5 | 5 |
| Formula 21A | 25 | 5/6 | 5/6 | 5 |
| Formula 22A | 25 | 5 | 5 | 5 |
| Formula 31A | 25 | 5/6 | 5 | 5 |
| Product D | 25 | 5/6 | 5/6 | 5 |

TABLE 8.C

| | | AATCC 118 - POLYAMIDE | | |
|---|---|---|---|---|
| | | Washes (40° C.-30 min)/Ironing | | |
| Product | g/L | 0 | 5 | 10 |
| Formula 20A | 25 | 6 | 6 | 5/6 |
| Formula 21A | 25 | 6 | 6 | 5/6 |
| Formula 22A | 25 | 6 | 6 | 5/6 |
| Formula 31A | 25 | 6 | 6 | 5/6 |
| Product D | 25 | 6 | 6 | 5/6 |

From the previous Tables 8.A, 8.B, 8.C the following conclusions can be drawn:

The tests performed with the isocyanates blocked with the oximes (i)-(iii) and the mixture thereof (iv) in formulation with Product C (fluorinated resin) show—with the same material (cotton, polyamide, polyester)—similar properties evaluated with AATCC Method 118, comparable with those obtained with Product D, reference product containing MEKO as blocking agent.

### C. AATCC 193: Water Repellency

Drops of a water/isopropyl alcohol mixture (IPA; isopropyl alcohol) with different proportions and different surface tensions are applied to a treated substrate. The drops are removed after 10 seconds and the absorption of the drop by the treated surface is evaluated. The water repellency grade is identified as the highest of the tested grades that is not completely absorbed within 10 seconds. The following Table 9 illustrates the water/IPA solutions used:

TABLE 9

| Test number of | Deionized | Isopropol | Surface |
|---|---|---|---|
| liquids water/ | water | alcohol | tension |
| isopropyl alcohol | (% volume) | (% volume) | (mN/m) |
| 1 | 98 | 2 | 59.00 |
| 2 | 95 | 5 | 49.75 |
| 3 | 90 | 10 | 41.60 |
| 4 | 80 | 20 | 32.50 |
| 5 | 70 | 30 | 27.40 |
| 6 | 60 | 40 | 25.40 |
| 7 | 50 | 50 | 24.50 |
| 8 | 40 | 60 | 24.00 |
| 9 | 30 | 70 | 23.40 |
| 10 | 20 | 80 | 22.70 |
| 11 | 10 | 90 | 21.90 |
| 12 | 0 | 100 | 21.80 |

The tests performed have been reported in Table 10.

TABLE 10

| Dry | Product (%) | |
|---|---|---|
| Product C | 30.05 | Product C --> Fluorinated Resin |
| FORMULA | 38.16 | Formula 20a --> Product C (80%) + |
| 20A | | Example 20a (20%) |
| FORMULA | 37.73 | Formula 21A --> Product C (80%) + |
| 21A | | Example 21A (20%) |
| FORMULA | 38.27 | Formula 22A --> Product C (80%) + |
| 22A | | Example 22A (20%) |
| FORMULA | 39.55 | Formula 31A --> Product C (80%) + |
| 31A | | Example 31A (20%) |
| Product D | 32.04 | Product D --> Product C (80%) + |
| | | Isocyanate blocked with MEKO (20%) |

Materials: Cotton
   Polyamide
   Polyester
Process: Application: Padding (P=3 bar)
   Drying: 120° C./1.5 min
   Cross-linking: 150° C./3 min
Required Tests: AATCC 193 (water/isopropyl alcohol resistance)
Results:

TABLE 10.A

| | | AATCC 193 - COTTON | | |
|---|---|---|---|---|
| | | Washes (40° C.-30 min)/Ironing | | |
| Product | g/L | 0 | 5 | 10 |
| FORMULA 20A | 25 | 7 | 7 | 6/7 |
| FORMULA 21A | 25 | 7 | 7 | 7 |
| FORMULA 22A | 25 | 7 | 7 | 7 |
| FORMULA 31A | 25 | 7 | 7 | 6/7 |
| Product D | 25 | 7 | 7 | 6/7 |

TABLE 10.B

| | | AATCC 193 - POLYESTER | | |
|---|---|---|---|---|
| | | Washes (40° C.-30 min)/Ironing | | |
| Product | g/L | 0 | 5 | 10 |
| FORMULA 20A | 25 | 8 | 8 | 8 |
| FORMULA 21A | 25 | 8 | 8 | 8 |
| FORMULA 22A | 25 | 8 | 8 | 8 |
| FORMULA 31A | 25 | 8 | 8 | 8 |
| Product D | 25 | 8 | 8 | 8 |

TABLE 10.C

| | | AATCC 193 - POLYAMIDE | | |
|---|---|---|---|---|
| | | Washes (40° C.-30 min)/Ironing | | |
| Product | g/L | 0 | 5 | 10 |
| FORMULA 20A | 25 | 8 | 8 | 8 |
| FORMULA 21A | 25 | 8 | 8 | 8 |
| FORMULA 22A | 25 | 8 | 8 | 8 |
| FORMULA 31A | 25 | 8 | 8 | 8 |
| Product D | 25 | 8 | 8 | 8 |

From the previous Tables 10.A, 10.B, 10.C the following conclusions can be drawn:

The tests performed with the isocyanates blocked with the oximes (i)-(iii) and the mixture thereof (iv) in formulation with Product C (fluorinated resin) show similar properties evaluated with Method AATCC 193, comparable with those obtained with Product D, reference product containing MEKO as blocking agent.

### Example 11: Fluorinated Resins and Their Methods of Preparation

The composition may comprise—in addition to said oximes (i)-(iv) or to said imidazole compound of general formula (I)—a polyacrylate consisting of several (meth)acrylic acid esters and optionally further ingredients chosen from paraffin wax and polysiloxanes. The entire composition is suitably used to treat a substrate such as fabrics or skins in order to give hydrophobic, or hydro/oleophobic properties in case the polyacrylate is functionalized with fluorinated chains.

Preferably, the polyacrylate is obtained by means of a copolymerization of the following monomer units (a)-(d):
(a) from 0.1% to 90% by weight of one or more acrylic or methacrylic monomers of general formula

Rf-Rh-OCOC(R₅)═CH₂
wherein:
R₅ is a methyl or hydrogen radical;
Rf is a linear or branched perfluorinated alkyl radical with a number of carbon atoms comprised from 1 to 6, preferably comprised from 4 to 6;
Rh is a group (CH₂)ₙ wherein n is an integer comprised from 1 to 6, preferably comprised from 2 to 4;
(b) from 0.1% to 80% by weight of one or more acrylic or methacrylic monomers of general formula (II):

Rz-OCOC(R₅)═CH₂ (II)
wherein:
Rz is a benzyl radical or an alkyl radical, linear or branched, comprising from 1 to 30 carbon atoms;
R₅ is a methyl or hydrogen radical;
(c) from 1% to 20% by weight of one or more monomers having at least one acrylic or methacrylic functional group and at least one carboxylic function of general formula R²-OCOC(R₅)═CH₂ where R² is (COOH)-(Rh)m- where Rh and R₅ are defined as above and m may assume the value 0 or 1, or itaconic acid;
(d) from 0.1% to 15% by weight of one or more monomers having at least one vinyl function;
(e) from 1% to 20% by weight of one or more acrylic or methacrylic monomers of general formula:

Ry-OCOC(R₅)═CH₂
wherein:
Ry is a radical R—[Si(CH3)2O]I—Si(CH3)2-(Rh)m-, where I is an integer comprised from 2 to 30 and R a linear or branched alkyl group with a number of carbon atoms from 1 to 20, Rh and m defined above;
R₅ is a methyl or hydrogen radical;
(f) 0-15% by weight of one or more acrylic or methacrylic monomers of general formula:

Rz-OCOC(R5)═CH₂
wherein Rz is a radical —R⁵-(Rh)m—, where R₅ is a hydroxyl or epoxy group and m is defined above.

Hereinafter, for the sake of brevity, the term “(meth)acrylate” or similar shall mean “acrylate or methacrylate”.

The synthesis of the (meth)acrylate polymer is carried out in two distinct steps:
homogenization of the mixture resulting from the sum of (meth)acrylic monomers, surfactants, water and/or organic solvents;
subsequent polymerization of the previously homogenized mixture.

The monomer mixture is heated until complete melting, preferably in the presence of solvents. The mixture is dispersed in hot water at 70° C. containing suitable surfactants, and is vigorously stirred using for example a Turrax. A subsequent step involves high pressure homogenization (e.g. 400 bar and a temperature of 65-75° C.) using a Manton-Gaulin type homogenizer. To the resulting mixture it is then added a radical initiator, possibly dissolved or dispersed in water. The polymerization reaction is carried out for several hours at a temperature of 60-70° C., until the monomers are exhausted.

Advantageously, for all the compounds subject-matter of the present invention the deblocking temperatures are not particularly high.

This aspect is an application advantage and is particularly important with a view to optimizing energy consumption and improving process productivity.

Advantageously, for all the compounds subject-matter of the present invention the presence of differentiated deblocking temperatures allows to obtain a series of flexibilities, for example necessary to optimize the processes of use of such compositions.

1. A composition comprising:
isocyanates blocked by means of a blocking agent selected from the group consisting of:
(i) optionally 2-pentanone oxime;
(ii) 4-methylpentane-2-one oxime;
(iii) 5-methyl-3-heptanone oxime; and
(iv) a mixture of two or more of (i)-(iii);
optionally one or more technological additives.

2. The composition according to claim 1, wherein said mixture (iv) comprises (iii) 5-methyl-3-heptanone oxime in combination with:
(i) 2-pentanone oxime; and/or
(ii) 4-methylpentane-2-one oxime.

3. The composition according to claim 2, wherein—in said mixture (iv):
a (iii):(i) or (iii):(ii) by weight ratio is comprised from 20:1 to 1:20; or
a [(iii)]:[(i)+(ii)] by weight ratio is comprised from 20:1 to 1:20.

4. The composition according to claim 1, wherein said (i) 2-pentanone oxime is not obtained by means of an ammoxidation reaction.

5. The composition according to claim 1, wherein said blocked isocyanates—ionic or non-ionic—are selected from the group consisting of:
(a) 1,5-pentamethylene diisocyanate (PDI) and polymers thereof;
(b) toluene diisocyanate (TDI) and adducts thereof;
(c) polyisocyanates derived from hexamethylenediisocyanate (HDI) obtained by means of trimerization, biuretization or allophanatization process(es);
(d) polyisocyanates derived from isophorone diisocyanate (IPDI) obtained by means of trimerization, biuretization or allophanatization process(es);
(e) 4,4′-methylene dicyclohexyl diisocyanate (H12MDI);
(f) trimethyl hexamethylene diisocyanate (TMDI);
(g) 1,4-cyclohexyl diisocyanate (CHDI);
(h) tetramethyl xylene diisocyanate (TMXDI); and
(i) any mixture of two or more selected from (a)-(h).

6. The composition according to claim 5, in which said blocked isocyanate, comprises a hexamethylene 1,6-diisocyanate trimer.

7. The composition according to claim 5, wherein said blocked isocyanate comprises a reaction product between trimethylolpropane and a mixture of 2,4 toluene diisocyanate and 2,6 toluene diisocyanate isomers.

8. The composition according to claim 1, wherein said composition is an aqueous suspension or dispersion.

9. The composition according to claim 1, wherein said composition is free of methyl ethyl ketoxime (MEKO).

10. A method comprising:
using a composition of
(ii) 4-methylpentane-2-one oxime;
(iii) 5-methyl-3-heptanone oxime; or
(iv) a mixture of two or more of (i)-(iii);
as an isocyanate blocking agent.

11. The method according to claim 10, wherein said mixture (iv) comprises (iii) 5-methyl-3-heptanone oxime in combination with:
(i) 2-pentanone oxime; or
(ii) 4-methylpentane-2-one oxime.

12. The method according to claim 11, wherein-in said mixture (iv):
a (iii):(i) or (iii):(ii) by weight ratio is comprised from 20:1 to 1:20; or
a [(iii)]:[(i)+(ii)] by weight ratio is comprised from 20:1 to 1:20.

13. The method according to claim 10, wherein said use comprises a deblocking of said isocyanates from said blocking agent in a water repellency or oil repellency treatment of a fabric or of a skin.

14. The method according to any one of claim 10, wherein said blocked isocyanate, comprises a hexamethylene 1,6-diisocyanate trimer.

15. The method according to claim 10, wherein said blocked isocyanate, comprises a reaction product between trimethylolpropane and a mixture of 2,4 toluene diisocyanate and 2,6 toluene diisocyanate isomers.

16. A composition consisting of:
isocyanates blocked by means of a blocking agent selected from the group consisting of:
(ii) 4-methylpentane-2-one oxime;
(iii) 5-methyl-3-heptanone oxime; and
(iv) a mixture of two or more of (i)-(iii);
optionally one or more technological additives.
